(19) United States
(12) Patent Application Publication
(10) Pub. No.: US 2010/0151854 A1
(43) Pub. Date: Jun. 17, 2010

(54) MOBILE APPARATUS, NETWORK CONTROL METHOD FOR MOBILE APPARATUS, AND COMPUTER-READABLE MEDIUM FOR MOBILE APPARATUS

(75) Inventor: Wan Wang, Sagamihara-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/475,745

(22) Filed: Jun. 1, 2009

(30) Foreign Application Priority Data
Dec. 15, 2008 (JP) P2008-318879

(51) Int. Cl. H04W 4/00

(52) U.S. Cl. 455/432.1

(57) ABSTRACT

A mobile apparatus including: a communication module; a first memory and a second memory configured to record first and second information respectively including at least home network information or home country information, the second information different from the first information; an information authentication module configured to determine whether the first and second information is valid or not through the communication module; a limiting module configured to limit a function of the mobile apparatus; a roaming module configured to perform roaming communication between networks; and a network control module configured to: permit the mobile apparatus to make a terminal operation using the second information when the first information is valid; and permit the mobile apparatus to make a terminal operation limited by the limiting module when the first information is invalid.

### CROSS-REFERENCE TO RELATED APPLICATIONS

The entire disclosure of Japanese Patent Application No. 2008-318879 filed on Dec. 15, 2008, including specification, claims, drawings and abstract is incorporated herein by reference in its entirety.

### BACKGROUND

1. Field of the Invention

One aspect of the invention relates to a mobile apparatus with a roaming function for enabling roaming communication between networks and particularly relates to a mobile apparatus with a Subscriber Identity Module (SIM) lock function, a network control method for the mobile apparatus and a computer-readable medium.

2. Description of the Related Art

Current communication networks are formed as a complex of communication networks provided by a plurality of providers with the recent advance of popularization of communication technology and diversification of communication providers. Communication networks are provided in both domestic and foreign sides. For example, standardization of communication methods enables communication between different networks put in the domestic and foreign sides.

Incidentally, a user of a communication network generally makes a service contract with a specific network provider so that the user can make communication under the network provided by the contract provider. However, for example, the user may want to make communication using a network provided by another provider than the first-mentioned contract provider when the user goes out of the user's country. Or the user may want to make communication with a network provided by another provider outside the user's country via the network provided by the contract provider. As described above, there is an increasing demand for communication in another network than the network provided by the contract provider or communication between different networks.

Therefore, a so-called roaming service has been achieved so that communication can be made via a network in a service area where the user is located currently even when the service area is out of service area of the network provided by the contract provider. If the main contract network provider ties up with another network provider in the service area with respect to roaming service, the user can use two networks after authentication of contract via the two networks.

Authentication using ‘SIM lock’ is widely used for contract authentication of a cellular phone which is a mobile apparatus used by the user. SIM contains subscriber information such as International Module Subscriber Identity (IMSI) as phone number information, Electric Serial Number (ESN) as terminal information, Mobile Country Code-Identifier (MCC-ID) as home country information, carrier information, etc. Generally, such SIM information is stored in a recording medium called ‘SIM card’. When the phone user inserts the SIM card into the cellular phone, the cellular phone reads the SIM information and makes network authentication. If it is confirmed as a result of the network authentication that the SIM information of the phone user is valid, the phone user can use the cellular phone. Otherwise, functions of the terminal are limited, for example, so that the communication function of the cellular phone is disabled.

Incidentally, in the related-art cellular phone, the fee to be paid for use of networks during roaming service is set to be rather high than the fee to be paid for use of a network provided by the contract provider. Particularly, even when the phone user moved to a new country out of the user's country and made communication with the communication terminal in the new country, the fee to be paid for use was high because the phone user had to use roaming service. To avoid such a high fee, the phone user had to make a new contract with a network provider in the new country before the phone user made domestic communication in the new country. It was inconvenient.

As an example to solve the problem, there has been disclosed a technique in which SIM cards having information about a plurality of service contracts are inserted in one cellular phone and one of the SIM cards is detected and authenticated automatically while the country where the cellular phone is currently located is regarded as home country (see JP-A-2007-235492, for instance). As another example to solve the problem, there has been disclosed a technique in which phone numbers stored in a database of a provider network are held in a server differently from phone numbers stored in SIM and one phone number cheapest in the fee to be paid for use of a network is selected from the stored phone numbers in accordance with the country where the cellular phone is currently located (see JP-A-2007-324778, for instance).

The techniques disclosed in JP-A-2007-235492 and JP-A-2007-324778 allow the phone user to use another different network from the network provided by the contract provider. For this reason, there was a problem that the contract provider could not hold the subscriber by SIM lock because the user could change the contract to a new one freely. There was another problem that a malicious user might remove an SIM card of a contract provider from a cellular phone and re-sell only the cellular phone illegally because the original contract provider had no chance of authentication after the change of SIM.

### SUMMARY

According to an aspect of the invention, there is provided a mobile apparatus mobile apparatus including: a communication module configured to communicate with a base station via a wireless communication line; a first memory configured to record first information including at least one piece of information of contract provider information, terminal information, phone number information, home network information and home country information; a second memory configured to record second information including at least one piece of information of contract provider information, terminal information, phone number information, home network information and home country information, the second information different from the first information; an information authentication module configured to determine whether the first and second information is valid or not through the communication module; a limiting module configured to limit a function of the mobile apparatus; a roaming module configured to perform roaming communication between networks; and a network control module configured to: permit the mobile apparatus to make a first terminal operation using the second information when the information authentication module determines that the first information is valid; and permit the mobile apparatus to make a second terminal operation limited by the limiting module when the information authentication module determines that the first information is invalid.

### BRIEF DESCRIPTION OF THE DRAWINGS

Embodiment may be described in detail with reference to the accompanying drawings, in which:

FIGS. 1A and 1B are exemplary views showing an external configuration of a foldable cellular phone as an example of a mobile apparatus according to an embodiment of the invention;

FIGS. 2A and 2B are exemplary views showing another external configuration of the foldable cellular phone as an example of the mobile apparatus according to the embodiment of the invention;

FIG. 3 is an exemplary diagram showing an internal configuration of the cellular phone according to this embodiment;

FIG. 4 is an exemplary diagram showing the configuration of a controller of the cellular phone according to this embodiment;

FIG. 5 is an exemplary conceptual view showing a state of network connection in a roaming function for performing roaming communication between networks;

FIG. 6 is an exemplary flow chart showing active SIM determination processing in a cellular phone which can hold a plurality of SIMs simultaneously; and

FIG. 7 is an exemplary flow chart showing SIM authentication processing in a cellular phone which holds a single SIM.

### DETAILED DESCRIPTION OF THE EMBODIMENTS

Embodiments of the invention as to a mobile apparatus will be described below with reference to the drawings.

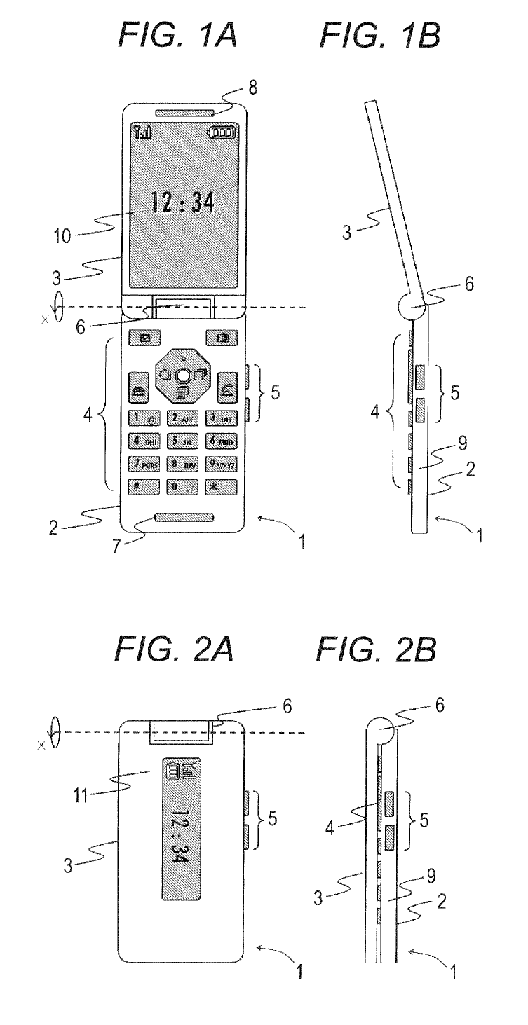

FIGS. 1A and 1B are views showing an external configuration of a foldable cellular phone 1 as an example of the mobile apparatus according to the invention. FIG. 1A is a front view showing the external configuration of the cellular phone 1 in a state where the cellular phone 1 is unfolded at an angle of about 180°. FIG. 1B is a side view showing the external configuration of the unfolded cellular phone 1.

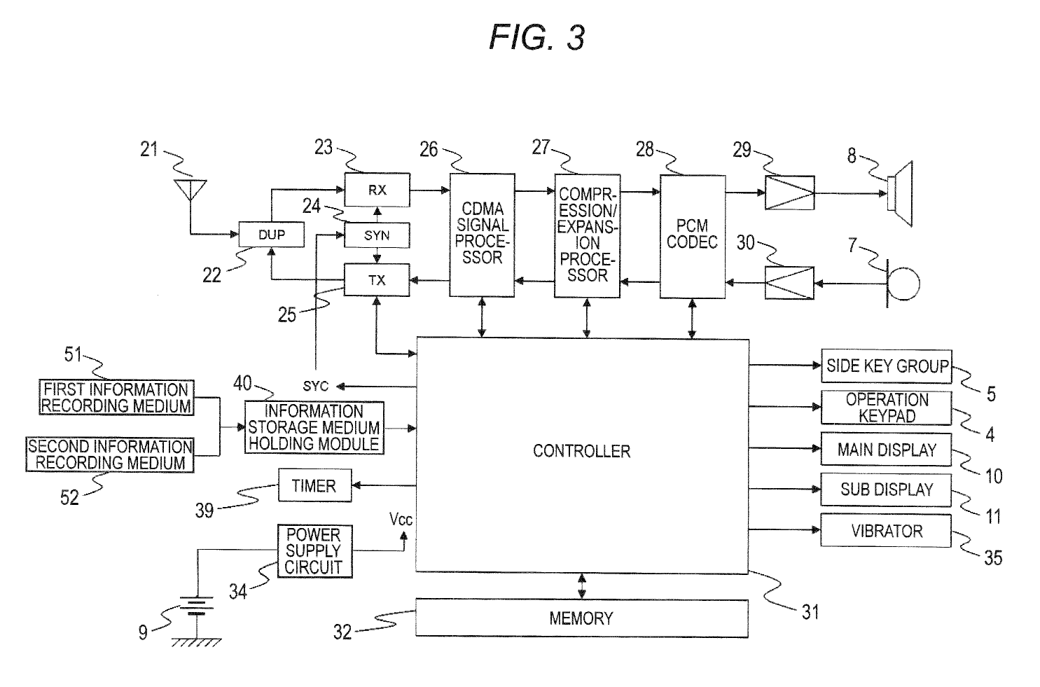

As shown in FIGS. 1A and 1B, the cellular phone 1 has a first casing 2 and a second casing 3 coupled to each other by a hinge portion 6 located in the center of the cellular phone 1 so that the cellular phone 1 is formed so as to be foldable in a direction of an arrow X through the hinge portion 6. An antenna for transmission and reception (i.e. an antenna 21 which will be described later with reference to FIG. 3) is provided in a certain position inside the cellular phone 1 so that electric wave is transmitted/received via the built-in antenna to/from a base station not shown.

An operation keypad 4 including numeric keys “0” to “9”, a call-in/call-out key, a redial key, a disconnect/power key, a clear key, a menu key, etc. is provided in a front face of the first casing 2. A side key group 5 is provided in a side face of the first casing 2. A user inputs various instructions and data into the cellular phone 1 by using the operation keypad 4 and the side key group 5.

A microphone 7 is provided in the first casing 2 so as to be located in a lower portion of the operation keypad 4. Voice of the user is collected by the microphone 7 during connection of the cellular phone 1.

Incidentally, a battery 9 is attached into a rear face of the first casing 2. When the cellular phone 1 is turned on by long-term pressing of the disconnect/power key, the battery 9 supplies electric power to respective circuit modules which will be described later.

On the other hand, a main display 10 is provided in a front face of the second casing 3. While an electric wave reception state and a residual battery capacity are displayed on the main display 10, a mail, a Web site, an operation menu of the cellular phone 1, etc. can be displayed on the main display 10. Incidentally, for example, the main display 10 is made of a liquid crystal display (LCD) or an organic electroluminescence (EL) display. A receiver 8 is provided in a certain position of an upper portion of the main display 10. The user can listen to voice transmitted from the connection partner by using the receiver 8.

An information recording medium holding module 40 which will be described later is provided in the first casing 2. The information recording medium holding module 40 is provided so that a first information recording medium 51 and a second information recording medium 52 which will be described later can be stored and held in the information recording medium holding module 40. The number of information recording media held in the information recording medium holding module 40 may be plural.

FIGS. 2A and 2B are views showing another external configuration of the cellular phone 1 in a state where the cellular phone 1 is folded. FIG. 2A is a view showing the external configuration of the cellular phone 1 in a state where the cellular phone 1 is folded. FIG. 2B is a side view showing the external configuration of the folded cellular phone 1.

A sub display 11, for example, made of an LCD is provided in a face of the second casing 3. For example, an antenna picture indicating the present antenna sensitivity level, a battery picture indicating the residual capacity of the battery 9 and the present time or the like are displayed on the sub display 11. The side key group 5 provided in the first casing 2 is located in an operable position even when the cellular phone 1 is folded.

FIG. 3 is a block diagram showing an internal configuration of the cellular phone 1 according to this embodiment.

A wireless signal transmitted from a base station not shown is received by the antenna 21 and then input to a reception circuit (RX) 23 through an antenna duplexer (DUP) 22. The received wireless signal is mixed with a local oscillation signal output from a frequency synthesizer (SYN) 24 so as to be down-converted into an intermediate frequency signal. The reception circuit 23 quadrature-demodulates the down-converted intermediate frequency signal to a reception baseband signal and outputs the reception baseband signal.

The reception baseband signal output from the reception circuit 23 is input to a CDMA signal processor 26. The CDMA signal processor 26 has a RAKE receiver not shown. The RAKE receiver performs inverse diffusion of a plurality of paths contained in the reception baseband signal by respective diffusion codes (i.e. the same diffusion codes as diffusion codes of diffused reception signal components). The inversely-diffused signals of the respective paths are subjected to coherent RAKE combining after the phase of each signal is rotated. After the RAKE combining, a data series is subjected to de-interleaving and channel decoding (error correction decoding) and then subjected to two-valued data evaluation. Consequently, the CDMA signal processor 26 generates reception packet data having a given transmission format. The reception packet data output from the CDMA signal processor 26 is input to a compression/expansion processor 27.

The compression/expansion processor 27 is made up of a digital signal processor (DSP), etc. The compression/expansion processor 27 demultiplexes the reception packet data output from the CDMA signal processor 26 into data according to media by using a multiplexing/demultiplexing module not shown and decodes the data according to media.

On the other hand, the user voice signal input to the microphone 7 in a connection mode is amplified to a proper level by a transmission amplifier 30 and then PCM-coded by a PCM codec 28. The PCM-coded digital audio signal is input to the compression/expansion processor 27. Text data such as a mail created by a controller 31 through the operation keypad 4 is input to the compression/expansion processor 27.

The compression/expansion processor 27 performs compression-coding of the digital audio signal output from the PCM codec 28 with a format corresponding to a given transmission data rate. Consequently, digital audio data is generated from the compression/expansion processor 27 to the CDMA signal processor 26. On the other hand, a digital motion picture signal output from the controller 31 is converted into compression-coded motion picture data by the compression/expansion processor 27. In the compression/expansion processor 27, these audio data and motion picture data are multiplexed according to a given transmission format by the multiplexing/demultiplexing module not shown and then packetized. After packetizing, transmission packet data is output to the CDMA signal processor 26.

The CDMA signal processor 26 performs spectrum diffusion of the transmission packet data output from the compression/expansion processor 27 by diffusion codes assigned to the transmission channel. The spectrum-diffused output signal is output to a transmission circuit (TX) 25. The transmission circuit 25 modulates the spectrum-diffused signal by a digital modulation method such as a Quadrature Phase Shift Keying (QPSK) method. The transmission circuit 25 up-converts the digital-modulated transmission signal into a wireless signal by combining the digital-modulated transmission signal with a local oscillation signal generated from the frequency synthesizer 24. The transmission circuit 25 amplifies the up-converted wireless signal to satisfy a transmission power level designated by the controller 31. The amplified wireless signal is fed to the antenna 21 through the antenna duplexer 22 and transmitted to a base station not shown via the antenna 21.

The cellular phone 1 further has a clock signal generator (timer) 39 which calculates a given period and supplies a clock signal to the controller 31 at time intervals of the given period.

The controller 31 has electronic circuits such as a Central Processing Unit (CPU), a Read Only Memory (ROM) and a Random Access Memory (RAM). The CPU performs processing in accordance with a program stored in the ROM or various application programs loaded from a memory 32 to the RAM. Moreover, the CPU generally controls the cellular phone 1 by generating various control signals and feeding the control signals to the respective circuit modules. Data necessary for the CPU to perform various kinds of processing is stored in the RAM. The RAM exchanges the data with the CPU. The controller 31 further has a video RAM not shown. Video information to be displayed on the main display 10 is temporarily stored in the video RAM. The memory 32 is made of an electrically rewritable and erasable nonvolatile memory such as a flash memory element, a Hard Disc Drive (HDD), etc. Various application programs performed by the CPU of the controller 31 and data sets necessary for the performance are stored in the memory 32. A power supply circuit 34 generates a given operating power supply voltage Vcc based on the voltage output of the battery 9 and supplies the voltage Vcc to the respective circuit modules.

The information recording medium holding module 40 reads information recorded on the first and second information recording media 51 and 52 and notifies the controller 31 of the information. For example, the information recorded on the first and second information recording media 51 and 52 contains International Mobile Subscriber Identity (IMSI) as phone number information, Electric Serial Number (ESN) as terminal information, Mobile Country Code-Identifier (MCC-ID) as country information, carrier information, etc. Generally, these pieces of information are stored in a recording medium called ‘SIM card’. The information recording medium holding module 40 is formed so that the SIM card can be removed from the information recording medium holding module 40.

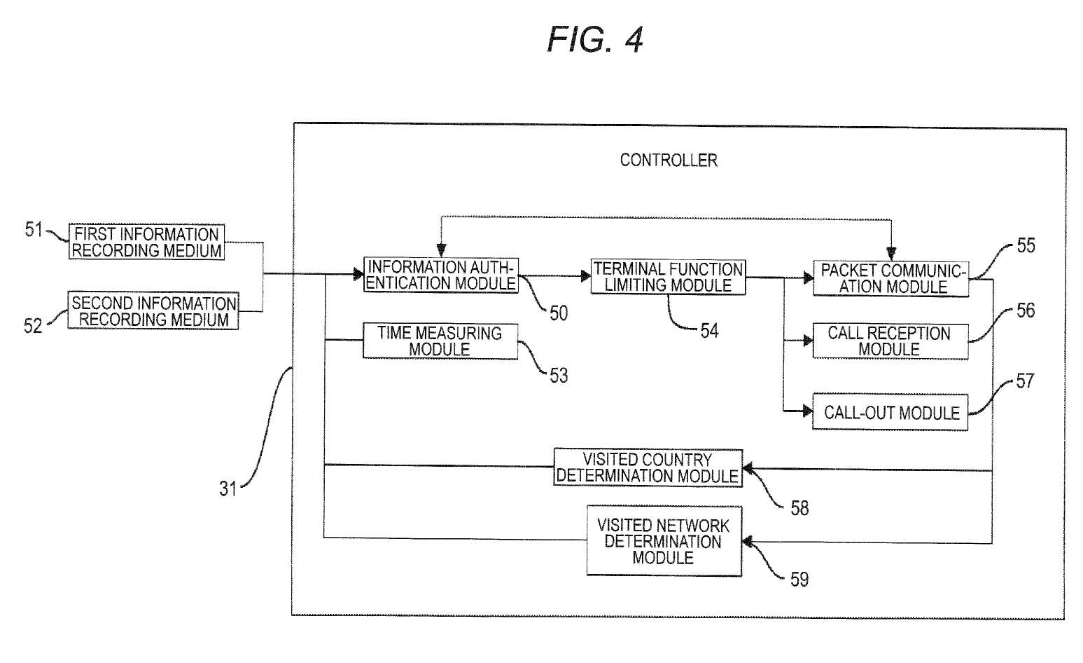

The configuration of the controller 31 in the cellular phone 1 according to this embodiment will be described below. FIG. 4 shows the internal configuration of the controller 31 of the cellular phone 1. The controller 31 has an information authentication module 50, a time measuring module 53, a terminal function limiting module 54, a packet communication module 55, a call reception module 56, a call-out module 57, a visited country determination module 58, and a visited network determination module 59. These modules may be formed as software or hardware.

The information authentication module 50 notifies the not-shown network of the information held in the first or second information recording medium 51 or 52 by using the packet communication module 55. The information authentication module 50 is a module which determines whether or not the information held in the first or second information recording medium 51 or 52 is information of a user having made a valid contract with the network provider, by using visited country information of the cellular phone 1 acquired from the visited country determination module 58, visited network information of the cellular phone 1 acquired from the visited network determination module 59 or time information acquired from the time measuring module 53.

The time measuring module 53 measures the present time and the elapsed time of a specific operation by using the timer 39 provided in the terminal or time information received as a wireless signal.

The terminal function limiting module 54 limits functions of the cellular phone 1 so as to disable the functions of the cellular phone 1 in response to an instruction given from the information authentication module 50. The functions to be limited are a data communication function using the packet communication module 55, a call-in function using the call reception module 56, a call-out function using the call-out module 57, etc. When the cellular phone 1 has other functions such as a camera function and a one-segment TV viewing function, these functions can be limited likewise.

The packet communication module 55 performs data communication with another cellular phone, a stationary terminal or a network control apparatus by using packet communication via a network not shown. The concept ‘data communication’ mentioned here includes not only data communication performed actively by the phone user such as exchange of an e-mail, browsing of a Web site, etc. but also data communication performed automatically without any operation of the phone user such as information authentication using the information authentication module 50, reception of a terminal control signal from the network, etc.

The call reception module 56 receives a call-out signal received from another cellular phone or a stationary terminal via the network.

The call-out module 57 transmits a call-out signal to another cellular phone or a stationary terminal via the network in response to an instruction given from the phone user.

The visited country determination module 58 acquires country information of a network currently used by the cellular phone 1 by using MCC-ID transmitted from the network and notifies the information authentication module 50 of the country information.

The visited network determination module 59 acquires information of a network currently used by the cellular phone 1 by using network information transmitted from the network and notifies the information authentication module 50 of the network information.

Incidentally, the configuration of the controller is not limited to the configuration shown in FIG. 4. For example, part of the configuration members shown in FIG. 4 may be omitted from the configuration shown in FIG. 4 or any configuration member not shown in FIG. 4 may be added to the configuration shown in FIG. 4.

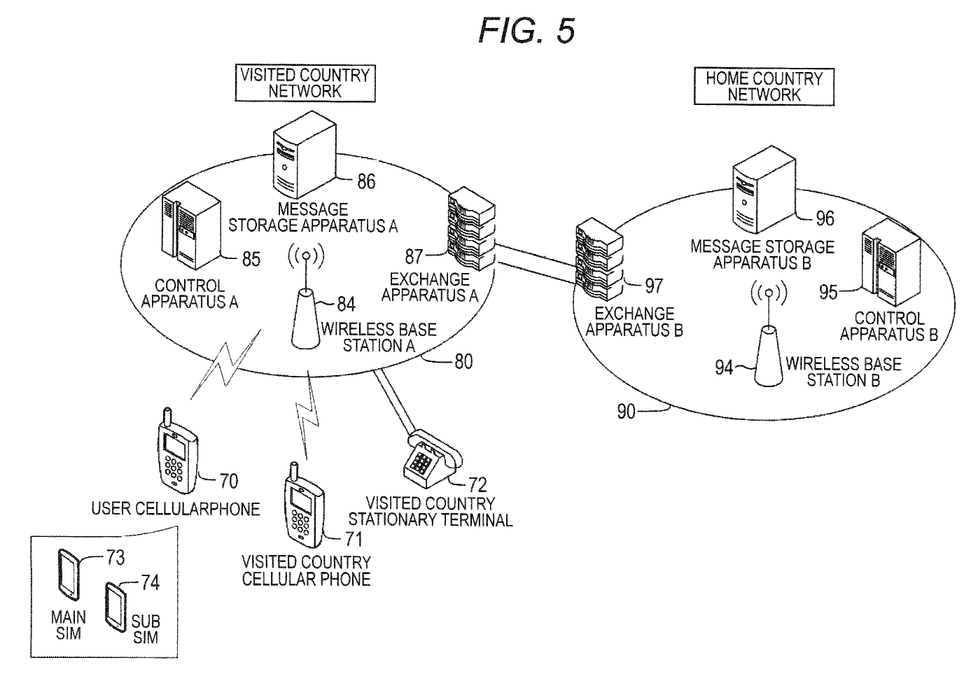

FIG. 5 is a conceptual view showing network connection between networks. Each network at least has an exchange apparatus A (87) or B (97), a control apparatus A (85) or B (95), a message storage apparatus A (86) or B (96), and a wireless base station A (84) or B (94).

The exchange apparatus A (87) or B (97) has a function of performing circuit exchange processing while controlling circuit connection in a network and between networks. The control apparatus A (85) or B (95) has a function of holding position information of a communication terminal existing in the network and contract information of a carrier to which the terminal belongs. The control apparatus A (85) or B (95) further has a function of designing a circuit route to a call-in destination in accordance with call-out of a communication terminal and outputting a control instruction to the exchange apparatus A (87) or B (97) to switch the designed circuit route into a conducting state. The control apparatus A (85) or B (95) further has a function of outputting a massage read instruction to the message storage apparatus (which will be described below) in accordance with a service request for an automatic answering service or the like of a communication terminal.

The message storage apparatus A (86) or B (96) has a function of holding information such as a mail transmitted from a user, a recorded message in automatic answering service or a transfer message and outputting a message to a communication terminal in accordance with a call instruction given from the control apparatus A (85) or B (95). The wireless base station A (84) or B (94) has a function of modulating a wire information signal propagated in the network to a wireless information signal and transmitting the wireless information signal while demodulating a wireless information signal transmitted from a cellular phone to a wire information signal and transmitting the wire information signal to the network.

### (Call-Out/Connection Processing Using Roaming Service)

Processing in a case where a user cellular phone 70 using roaming service is connected to a visited country cellular phone 71 or a visited country stationary terminal 72 by calling the visited country cellular phone 71 or the visited country stationary terminal 72 will be described below.

First, when the user cellular phone 70 on the transmission side issues a transmission request toward the visited country cellular phone 71 or the visited country stationary terminal 72, the transmission request is transmitted to the wireless base station A (84) Upon reception of the transmission request, the wireless base station A (84) demodulates the received signal and transmits the demodulated transmission request to the control apparatus A (85). Upon reception of the transmission request, the control apparatus A (85) confirms information of a home country network provider with which the user cellular phone 70 has made a contract, based on information of an SIM inserted in the user cellular phone 70.

Further, the control apparatus A (85) determines whether or not the home country network provider is the same as a visited country network provider to which the wireless base station A (84) used by the user cellular phone 70 belongs. When the home country network provider with which the user cellular phone 70 has made a contract is not the same as the visited country network provider to which the wireless base station A (84) belongs, the control apparatus A (85) transmits the International Module Subscriber Identity (IMSI) as phone number information and Electric Serial Number (ESN) as terminal information of the user cellular phone 70 to the control apparatus B (95), for example, belonging to a home country network 90 with which the user cellular phone 70 has made a contract. The control apparatus B (95) determines whether or not the contract with the home country network provider is valid and whether or not the contract for permitting use of roaming service of the visited country network 80 is valid.

When the contract with the home country network provider is invalid or when the contract to use roaming service is invalid, the call-out request is discarded and the circuit is disconnected. When both the contracts are valid, the control apparatus B (95) transmits a result of determination to the control apparatus A (85). Further, when the control apparatus B (95) confirms that the user cellular phone 70 is enabled to use the visited country network 80, the control apparatus B (95) designs a circuit route to connect the user cellular phone 70 to a call-out destination. Open Shortest Path Fast (OSPF) is generally used for designing the circuit route. OSPF is a routing protocol which can select a most cost-effective route in terms of total communication cost of the circuit route in a state where communication cost is set in advance in accordance with each circuit.

The control apparatus B (95) drives the exchange apparatus A (87) and the exchange apparatus B (97) to connect circuits so that communication can be performed via the designed circuit route. The control apparatus B (95) notifies the user cellular phone 70 (which is a call-out source) and the visited country cellular phone 71 or the visited country stationary terminal 72 (which is a call-in destination) of the connection of circuits. In this manner, connection between the terminals is started.

As described above, in local connection in a visited country due to use of roaming service, the user cellular phone 70 needs to make communication via the home country network 90. Communication via the home country network 90 brings a large processing load on network compared with domestic connection in the visited country network 80. In addition, communication via the home country network 90 causes the user a relatively high fee for a call.

### (Call-Out/Connection Processing Using Local Communication)

Processing in a case where the user cellular phone 70 is connected to the visited country cellular phone 71 or the visited country stationary terminal 72 by calling the visited country cellular phone 71 or the visited country stationary terminal 72 by using an SIM having a contract with the visited country network 80 will be described below.

A call-out request transmitted from the user cellular phone 70 is received by the control apparatus A (85) in the same manner as in the call-out using roaming service. The control apparatus A (85) confirms information of a home country network provider with which the user cellular phone 70 has made a contract, based on information of the SIM inserted in the user cellular phone 70 and determines whether or not the home country network provider is the same as the visited country network provider to which the wireless base station A (84) used by the user cellular phone 70 belongs. When the home country network provider is the same as the visited country network provider, the control apparatus A (85) designs a circuit route to connect the user cellular phone 70 to a call-out destination. The control apparatus A (85) drives the exchange apparatus A (87) to connect circuits so that communication can be performed via the designed circuit route. The control apparatus A (85) notifies the user cellular phone 70 (which is a call-out source) and the visited country cellular phone 71 or the visited country stationary terminal 72 (which is a call-in destination) of the connection of circuits. In this manner, connection between the terminals is started.

As described above, in connection in such a local area, call-out and connection processing performed by the user cellular phone 70 is only in the visited country network 80. Connection in the local area brings a small processing load on network compared with connection using roaming service. In addition, connection in the local area causes the user a relatively low fee for a call.

Two embodiments will be described below in a case where a plurality of SIMs are used to permit local connection when the user cellular phone 70 is moved out of the user's country and the user makes a telephone call by using the network 80 in a visited country different from the home country of an SIM used ordinarily. A first embodiment shows a technique in which SIMs can be held simultaneously so that an SIM used is selected in accordance with the contract state of the user cellular phone 70 and the state of networks. A second embodiment shows a technique in which an SIM can be exchanged for a different one so that switching from an ordinary used SIM to a different SIM is permitted in response to a control signal transmitted from the control apparatus B (95) in the home country.

### First Embodiment

The first embodiment is configured so that an information recording medium holding module 40 capable of holding two SIM cards is provided in the cellular phone 1. A main SIM 73 used in the home country is provided as one of the SIM cards. A sub SIM 74 having a contract to use local communication in the visited country network 80 is provided as the other of the SIM cards.

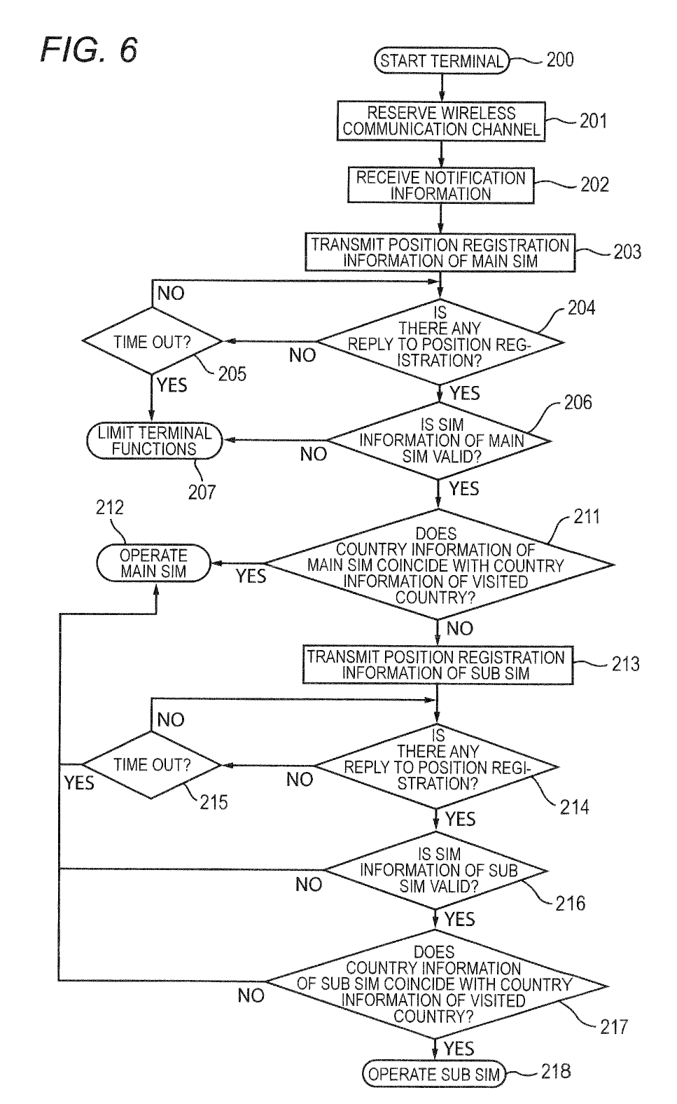

A processing procedure for determining an SIM to be used will be described below. FIG. 6 is a flow chart showing processing for determining an SIM to be used by the user cellular phone 70.

First, when the user cellular phone 70 starts (step 200), the user cellular phone 70 reserves a wireless communication channel used by itself based on an wireless signal received from the wireless base station A (84) (step 201). After the wireless communication channel is reserved, the user cellular phone 70 receives notification information transmitted from the wireless base station A (84) (step 202). The notification information includes position information of a cell to which the wireless base station A (84), carrier information, country information, etc. Then, the user cellular phone 70 tries position registration by using the main SIM 73 (step 203). The user cellular phone 70 transmits information stored in the main SIM 73 to the control apparatus A (85) for position registration. For example, the transmitted information includes IMSI, ESN, carrier information, MCC-ID, etc.

After the position registration information is transmitted, the user cellular phone 70 waits for a reply signal from the control apparatus A (85) (step 204). When there is no reply, the user cellular phone 70 waits for reception of the reply signal or time-out (step 205). When there is no reply signal after a threshold time has passed, time-out is determined and the terminal function limiting module 54 of the user cellular phone 70 limits use of a call-out function, a call-in function, a data communication function or the like (step 207). Upon reception of the position registration information from the user cellular phone 70, the control apparatus A (85) determines whether the contract in use of the main SIM 73 is valid or not, by using IMSI, ESN, carrier information, MCC-ID, etc. and transmits a result of the determination to the user cellular phone 70 (step 203). The user cellular phone 70 checks whether the contract in use of the main SIM 73 is valid or not from the result of the determination (step 206). When the contract in use of the main SIM 73 is invalid, functions of the terminal are limited by the terminal function limiting module 54 (step 207).

After the control apparatus A (85) confirms that the contract in use of the main SIM 73 is valid, the control apparatus A (85) checks whether the country where the user cellular phone 70 exists is the home country or not, by using MCC-ID (step 211). When the control apparatus A (85) notifies the user cellular phone 70 of the confirmation that the country where the user cellular phone 70 exists is the home country, the user cellular phone 70 performs local communication using the position registration of the main SIM 73 (step 212).

When the control apparatus A (85) notifies the user cellular phone 70 of the confirmation that the country where the user cellular phone 70 exists is not the home country, the user cellular phone 70 transmits position registration information of the sub SIM 74 to the control apparatus A (85) to try position registration using the sub SIM 74 (step 213). The user cellular phone 70 waits for a reply signal from the control apparatus A (85) in the same manner as in position registration of the main SIM 73 (step 214). When there is no reply, the user cellular phone 70 waits for reception or time-out of the reply signal (step 215). When there is no reply signal received after a threshold time has passed, the user cellular phone 70 regards the reply as time-out and performs roaming communication using the main SIM 73 with respect to which position registration has been already made (step 212).

On the other hand, when the user cellular phone 70 receives a result of determination as to whether the contract of the sub SIM 74 is valid or not, from the control apparatus A (85), the user cellular phone 70 determines whether the contract of the sub SIM 74 is valid or not (step 216). When the user cellular phone 70 determines that the contract of the sub SIM 74 is invalid, the user cellular phone 70 performs roaming communication using the position information of the main SIM 73 (step 212). When determination is made that the contract of the sub SIM 74 is valid, the control apparatus A (85) checks whether or not the country where the user cellular phone 70 exists is the home country of the sub SIM 74, by using MCC-ID (step 217). When the control apparatus A (85) confirms that the country where the user cellular phone 70 exists is not the home country of the sub SIM 74, and notifies the user cellular phone 70 of this information, the user cellular phone 70 performs roaming communication using the main SIM 73 (step 212). When the control apparatus A (85) confirms that the country where the user cellular phone 70 exists is the home country of the sub SIM 74, and notifies the user cellular phone 70 of this information, the user cellular phone 70 performs local communication using the position registration information of the sub SIM 74 (step 218).

By the aforementioned procedure, the user cellular phone 70 having the two SIMs 73 and 74 held therein can perform communication using a selected SIM 73 or 74 in accordance with the country where the user cellular phone 70 exists. Incidentally, as shown in FIG. 6, validity of the main SIM 73 is checked at the start of communication. When the validity check results in that the main SIM 73 is invalid, the user cellular phone 70 cannot perform communication regardless of validity of the sub SIM 74. Accordingly, the user can be permitted to use roaming service in the visited country while the service contract of the user with the network provider is maintained. Moreover, illegal re-sale in the visited country can be prevented.

Although this embodiment has been described on the case where the cellular phone 1 uses two SIMs, the same effect of the invention can be obtained in the case where the number of SIMs increases, that is, the cellular phone can hold three or more SIMs. Although this embodiment has been described on the case where country information is used as information to be checked in the steps 211 and 217, the same effect of the invention can be obtained in the case where carrier information or information of a network to which the user cellular phone 70 belongs is used as information to be checked in the steps 211 and 217.

### Second Embodiment

The second embodiment shows an example in which an information recording medium holding module 40 capable of holding one SIM card is provided in the cellular phone 1.

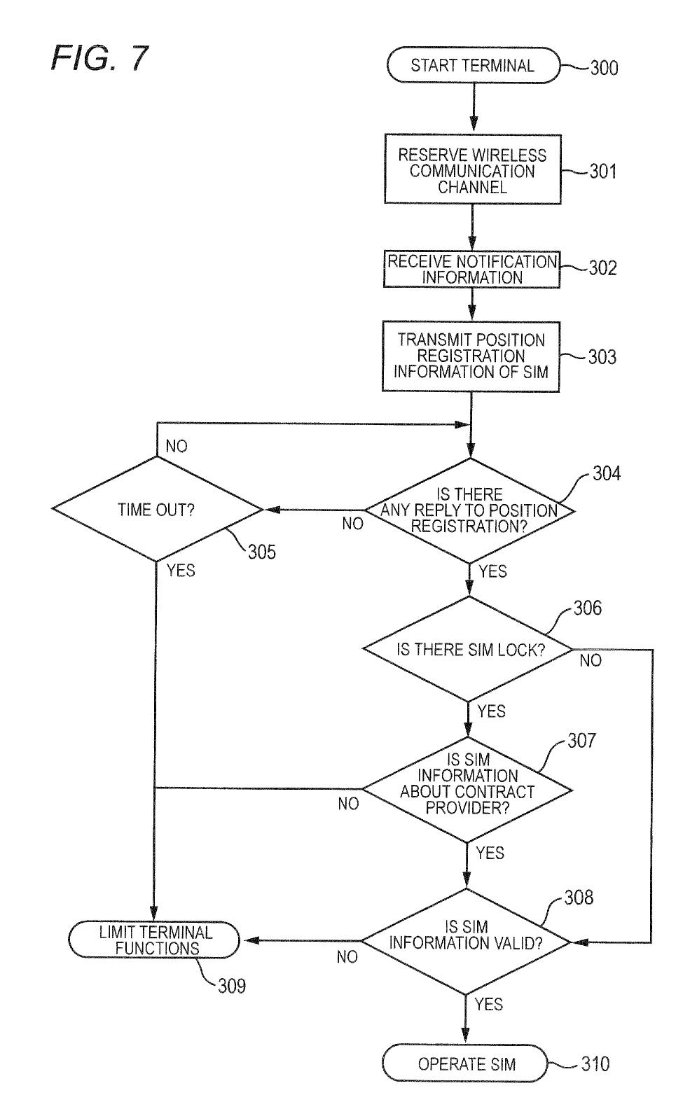

In the second embodiment, position registration using the main SIM 73 is performed in advance so that the control apparatus B (95) transmits an SIM lock cancellation control signal when determination is made that the contract in use of the main SIM 73 is valid. The term ‘SIM lock’ means a terminal function limiting function which is performed, for example, when carrier information of the main SIM 73 inserted in the user cellular phone 70 does not coincide with carrier information recorded on the user cellular phone 70. When the user cellular phone 70 in an SIM unlock state performs position registration by using the sub SIM 74 having a contract to use in a country where the user cellular phone 70 exists, local communication in the visited country network 80 is enabled. FIG. 7 is a flow chart showing SIM authentication processing at the start of a terminal. The procedure of the processing will be described below.

First, when the user cellular phone 70 starts (step 300), the user cellular phone 70 reserves a wireless communication channel based on an electric wave signal received from the wireless base station A (84) (step 301). After the wireless communication channel is reserved, the user cellular phone 70 receives notification information transmitted from the wireless base station A (84) (step 302). The user cellular phone 70 transmits position registration information to the control apparatus A (85) through the wireless base station A (84) by using the SIM currently inserted in the user cellular phone 70 (step 303). Then, the user cellular phone 70 waits for a reply signal from the control apparatus A (85) (step 304). When there is no reply, the user cellular phone 70 waits for reception of the reply signal or time-out (step 305). When there is no reply signal after a threshold time has passed, time-out is determined and the terminal function limiting module 54 limits functions of the user cellular phone 70 (step 309).

Upon reception of the reply signal, the user cellular phone 70 determines whether SIM lock is imposed or not (step 306). When SIM lock is imposed, the user cellular phone 70 checks whether or not carrier information of the SIM currently inserted in the user cellular phone 70 coincides with carrier information recorded on the user cellular phone 70 (step 307). When carrier information of the SIM does not coincide with carrier information recorded on the user cellular phone 70, the user cellular phone 70 operates the terminal function limiting module 54 to limit functions of the user cellular phone 70 (step 309). On the other hand, when the user cellular phone 70 confirms that carrier information of the SIM coincides with carrier information recorded on the user cellular phone 70 or that SIM lock is not imposed, the user cellular phone 70 checks whether the contract in use of the SIM currently inserted in the user cellular phone 70 is valid or not, based on a reply signal received from the control apparatus A (85) or B (95) (step 308). When the contract in use of the SIM is invalid, functions of the user cellular phone 70 are limited by the terminal function limiting module 54 (step 309). When the contract is valid, the user cellular phone 70 performs local communication using position registration information of the SIM currently inserted in the user cellular phone 70 (step 310).

By the aforementioned procedure, the user cellular phone 70 in an SIM unlock state in advance can perform local communication when the main SIM is replaced by a proper SIM adapted to the visited country network 80 to which the user cellular phone 70 currently belongs. Incidentally, as described above, SIM lock can be canceled only when the control apparatus B (95) of the home country network 90 confirms that the contract of the main SIM 73 for use of the home country network 90 is valid. Accordingly, the network provider can permit the user to use local connection in the country where the user cellular phone 70 exists while the contract between the user and the network provider is maintained.

Incidentally, the SIM lock cancellation is performed based on a control signal transmitted from the control apparatus B (95). A signal indicating a threshold SIM unlock period may be added to the control signal so that SIM lock can be imposed on the user cellular phone 70 again after the threshold SIM unlock period has passed. Accordingly, the user cellular phone 70 in an SIM unlock state cannot be used permanently in the visited country, so that illegal re-sale of the user cellular phone 70 in the visited country can be prevented. Further, country information for SIM lock cancellation may be added to the control signal transmitted from the control apparatus B (95) so that SIM lock can be canceled only when the network to which the user cellular phone 70 belongs exists in a specific country at the time of position registration of the SIM. In this manner, the home country network provider can designate any country to which SIM unlock service should be provided.

As described above, in accordance with this embodiment, a cellular phone cheap in the fee to be paid for use of a network can be provided because the phone user under roaming can perform local communication by using an SIM in a service area. Moreover, a cellular phone in which local connection in the visited country can be permitted while the service contract between the user and the network provider is maintained and in which illegal re-sale of the cellular phone can be prevented can be provided because replacement of SIM information in the visited country is permitted after SIM authentication is performed by the home country contract provider.

Although the embodiments have been described on a cellular phone by way of example, the scope of the invention is not limited thereto. For example, the invention can be applied to a communication terminal such as a Personal Digital Assistant (PDA), a wired terminal, etc. Although the embodiments have been described on the case where the cellular phone is a foldable cellular phone by way of example, the invention can be applied to a slide type cellular phone or a bar type cellular phone having no movable mechanism. The invention is not limited to the aforementioned embodiments and may be embodied by modified configuration members without departing from a point of the invention. Moreover, configuration members disclosed in each of the embodiments may be used in suitable combination to thereby form various inventions. For example, several configuration members may be omitted from all the configuration members disclosed in each of the embodiments. In addition, configuration members disclosed in different embodiments may be used in suitable combination.

What is claimed is:

1. A mobile apparatus comprising:
a communication module configured to communicate with a base station via a wireless communication line;
a first memory configured to record first information including at least one piece of information of contract provider information, terminal information, phone number information, home network information and home country information;
a second memory configured to record second information including at least one piece of information of contract provider information, terminal information, phone number information, home network information and home country information, the second information different from the first information;
an information authentication module configured to determine whether the first and second information is valid or not through the communication module;
a limiting module configured to limit a function of the mobile apparatus;
a roaming module configured to perform roaming communication between networks; and
a network control module configured to:
permit the mobile apparatus to make a first terminal operation using the second information when the information authentication module determines that the first information is valid; and
permit the mobile apparatus to make a second terminal operation limited by the limiting module when the information authentication module determines that the first information is invalid.

2. The mobile apparatus of claim 1, wherein, when the information authentication module determines that the first information is valid:
the network control module is configured to permit the mobile apparatus to make a third terminal operation using the first information when the home network information or the home country information in the first information corresponds to information of a network or country to which the mobile apparatus belongs; and
the network control module is configured to permit the mobile apparatus to make the first terminal operation using the second information when the home network information or the home country information in the first information does not correspond to the information of a network or country to which the mobile apparatus belongs.

3. The mobile apparatus of claim 2, wherein, when the information authentication module determines that the first information is valid and when the home network information or the home country information in the first information does not correspond to the information of a network or country to which the mobile apparatus belongs:
the network control module is configured to permit the mobile apparatus to make the first terminal operation using the second information when the home network information or the home country information in the second information corresponds to the information of a network or country to which the mobile apparatus belongs; and
the network control module is configured to permit the mobile apparatus to make the third terminal operation using the first information when the home network information or the home country information in the second information does not correspond to information of a network or country to which the terminal belongs.

4. The mobile apparatus of claim 1, wherein the network control module is configured to permit the mobile apparatus to make the first terminal operation using the second information based on a control signal received via the wireless communication line by the communication module when the information authentication module determines that the first information is valid.

5. The mobile apparatus of claim 4, wherein the network control module is configured to permit the mobile apparatus to make the first terminal operation using the second information during a period determined in advance.

6. The mobile apparatus of claim 4, wherein the network control module is configured to permit the mobile apparatus to make the first terminal operation using the second information when the home country information or the home network information in the second information corresponds to information of a country or network determined in advance.

7. The mobile apparatus of claim 5, wherein the network control module is configured to permit the mobile apparatus to make the first terminal operation using the second information when the home country in formation or the home network information in the second information corresponds to information of a country or network determined in advance.

8. A network control method for a mobile apparatus having: a communication module configured to communicate with a base station via a wireless communication line; a first memory configured to record first information including at least one piece of information of contract provider information, terminal information, phone number information, home network information and home country information; a second memory configured to record second information including at least one piece of information of contract provider information, terminal information, phone number information, home network information and home country information, the second information different from the first information; an information authentication module configured to determine whether the first and second information is valid or not through the communication module; a limiting module configured to limit a function of the mobile apparatus; and a roaming module configured to perform roaming communication between networks, the network control method comprising:
permitting the mobile apparatus to make a first terminal operation using the second information when the information authentication module determines that the first information is valid; and
permitting the mobile apparatus to make a second terminal operation limited by the limiting module when the information authentication module determines that the first information is invalid.

9. The network control method of claim 8, further comprising:
permitting the mobile apparatus to make a third terminal operation using the first information when the information authentication module determines that the first information is valid and when the home network information or the home country information in the first information corresponds to information of a network or country to which the mobile apparatus belongs; and
permitting the mobile apparatus to make the first terminal operation using the second information when the information authentication module determines that the first information is valid and when the home network information or the home country information in the first information does not correspond to the information of a network or country to which the mobile apparatus belongs.

10. A computer-readable medium containing software instructions for causing a mobile apparatus to perform a network control process, the mobile apparatus including the computer; a communication module configured to communicate with a base station via a wireless communication line; a first memory configured to record first information including at least one piece of information of contract provider information, terminal information, phone number information, home network information and home country information; a second memory configured to record second information including at least one piece of information of contract provider information, terminal information, phone number information, home network information and home country information, the second information different from the first information; an information authentication module configured to determine whether the first and second information is valid or not through the communication module; a limiting module configured to limit a function of the mobile apparatus; and a roaming module configured to perform roaming communication between networks, wherein the software instructions comprise:
permitting the mobile apparatus to make a first terminal operation using the second information when the information authentication module determines that the first information is valid; and
permitting the mobile apparatus to make a second terminal operation limited by the limiting module when the information authentication module determines that the first information is invalid.

11. The computer-readable medium of claim 10, wherein the software instructions further comprise:
permitting the mobile apparatus to make a third terminal operation using the first information when the information authentication module determines that the first information is valid and when the home network information or the home country information in the first information corresponds to information of a network or country to which the mobile apparatus belongs; and
permitting the mobile apparatus to make the first terminal operation using the second information when the information authentication module determines that the first information is valid and when the home network information or the home country information in the first information does not correspond to the information of a network or country to which the mobile apparatus belongs.
